(19) United States
(12) Patent Application Publication
(10) Pub. No.: US 2008/0025498 A1
(43) Pub. Date: Jan. 31, 2008

(54) MONTGOMERY POWER LADDER ALGORITHM INCLUDING COUNTERMEASURE AGAINST DIFFERENTIAL FAULT ANALYSIS

(76) Inventor: Ihor Vasyltsov, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/622,508

(22) Filed: Jan. 12, 2007

(30) Foreign Application Priority Data
Jan. 14, 2006 (KR) 10-2006-0004175

(51) Int. Cl. H04L 9/28

(52) U.S. Cl. 380/28

(57) ABSTRACT

A Montgomery power ladder algorithm that provides a countermeasure against a differential fault analysis (DFA) includes an initialization operation and a repetitive arithmetic operation. In the initialization operation, an initial value of a variable i, which will be used in the repetitive arithmetic operation, is set, a basic point P on an elliptic curve and a scalar k are received, and at least two variables are initialized using the basic point P. In the repetitive arithmetic operation, a value Q is computed by multiplying the scalar k by the basic point P by using the two variables, whether a fault was induced during the multiplication is determined by determining the relationship between the two variables and the basic point P, and the value Q or a warning signal STOP is output according to the determination result.

### CROSS-REFERENCE TO RELATED PATENT APPLICATION

This application claims the priority of Korean Patent Application No. 10-2006-0004175 filed on 14 Jan. 2006, in the Korean Intellectual Property Office, the disclosure of which is incorporated herein in its entirety by reference.

### BACKGROUND OF THE INVENTION

1. Technical Field

The present disclosure relates to a cryptographic system and, more particularly, to a Montgomery power ladder algorithm that provides a countermeasure for a differential fault analysis (DFA).

2. Discussion of Related Art

The birth of the so-called Information Society has significantly increased the importance of information protection using cryptographic algorithms and protocols. An open key-based cryptographic algorithm, used in a Rivest-Shamir-Adleman (RSA) cryptographic system and an elliptic curve cryptography (ECC) cryptographic system, provides a solution to the problems (key distribution, electronic signature, etc.) of a secret key-based cryptographic algorithm. Thus, the open key-based cryptographic algorithm has been often used in various fields, for example, the Internet or financial networks.

Side channel analysis is generally used to break an RSA cryptographic system or an ECC cryptographic system. Timing analysis, power analysis, electromagnetic analysis, and fault analysis are well-known examples of the side channel analysis. In particular, the side channel analysis is an effective attack method when the hardware construction of a cryptographic system to be attacked is known.

In differential fault analysis (DFA), which is an example of the fault analysis, a secret key of a cryptographic system under attack is calculated using the difference between certain variables. That is, a secret key of the cryptographic system is detected by inserting a fault into the cryptographic system and analyzing the result of performing an operation corresponding to the inserted fault. A value that is to be stored, or that has been stored, in a register of the cryptographic system is changed by the fault. Since the value stored in the register is used when the cryptographic system performs a predetermined operation, an error corresponding to the value changed by the fault is included in the result of the predetermined operation. Thus, a cryptanalyst can interpret the result of the predetermined operation including the error to obtain information regarding the secret key of the cryptographic system.

Various countermeasure methods against DFA in ECC have been introduced.

FIG. 1 is a flowchart illustrating a conventional CT&C (Calculate Twice and Check) method 100 providing a countermeasure against DFA. Referring to FIG. 1, a point P on an elliptic curve is selected (110), a first comparison value Q1 is computed by multiplying the point P by a predetermined integer k (120) at a predetermined time, a second comparison value Q2 is computed by multiplying the point P by the integer k (130) at another predetermined time, and the first comparison value Q1 is compared with the second comparison value Q2 (140).

When the first and second comparison values Q1 and Q2 are the same, it is determined that no fault has affected the multiplication and, thus, one of the first and second comparison values Q1 and Q2 is output as the operation result Q (150). When first and second comparison values Q1 and Q2 are not the same, however, it is determined that a fault has affected the multiplication and, thus, a warning signal is output instead of the operation result Q (160).

Here, it is assumed that all faults are randomly induced without a predetermined rule and a probability that the same fault will affect the first and second comparison values Q1 and Q2 is negligible. Also, the integer k denotes a secret key, and the first and second comparison values Q1 and Q2 are computed at different instants of time.

The CT&C method 100 of FIG. 1 is applicable to various cryptographic algorithms, such as a symmetric algorithm, an asymmetric algorithm, and a stream algorithm, but is disadvantageous in that the same multiplication must be performed twice. Also, since faults are always present in regions where most of the smart cards and mobile devices are used, the CT&C method 100 cannot be applied directly to the smart cards or the mobile devices.

FIG. 2 is a flowchart illustrating a conventional COP (Check-the-Output-Point) method 200 providing a countermeasure against DFA. Referring to FIG. 2, a point P on an elliptic curve E is selected (210), a comparison value Q is computed by multiplying the point P by a predetermined integer k (220), and it is determined whether the comparison value Q is the value of a point on the elliptic curve E (230).

If the comparison value Q is the value of a point on the elliptic curve E, it is determined that no fault has affected the multiplication and, thus, the comparison value Q is output (240). When the comparison value Q is not the value of a point on the elliptic curve E, however, it is determined that the fault has affected the multiplication and, thus, a warning signal is output instead of the comparison value Q (250).

Here, it is assumed that all faults are randomly induced without a predetermined rule, and a probability that the comparison value Q will be the value of a point on the elliptic curve E due to a fault affecting the multiplication is negligible. Also, the integer k denotes a secret key.

The COP method 200 provides a countermeasure against DFA without degrading the performance of the cryptographic system. Since the COP method 200 is applicable only to ECC-based cryptographic systems, however, the application range thereof is limited. Also, the performance of the system is significantly degraded when dealing with an attack using a fault whose sign changes.

### SUMMARY OF THE INVENTION

Exemplary embodiments of the present invention provide a Montgomery power ladder algorithm that provides a countermeasure against DFA. The algorithm is computationally simple, can be used in a region where a fault is always present, and is applicable to various cryptographic systems such as an ECC cryptographic system and an RSA cryptographic system.

According to an exemplary embodiment of the present invention, there is provided a Montgomery power ladder algorithm that provides a countermeasure against differential fault analysis (DFA) by performing a scalar multiplication operation in a prime finite field or a binary finite field.

The algorithm provides initializing at least two variables by setting an initial value of a variable i, which is to be used in a repetitive arithmetic operation; receiving a basic point P on an elliptic curve and a scalar k; and initializing the at least two variables using the basic point P.

The algorithm further includes repeatedly performing the scalar multiplication operation by computing a value Q by multiplying the scalar k by the basic point P using the two variables, determining whether a fault was induced during the multiplication by analyzing the relationship between the two variables and the basic point P, and outputting the value Q or a warning signal STOP according to the determination result.

According to an exemplary embodiment of the present invention, there is provided a Montgomery power ladder algorithm that provides a countermeasure against differential fault analysis (DFA) by performing a scalar multiplication operation in a prime finite field or a binary finite field.

The algorithm provides initializing at least two variables by setting an initial value of a variable is, which is to be used in a repetitive arithmetic operation, receiving a basic point P on an elliptic curve and a scalar k, and initializing the at least two variables using the basic point P.

The algorithm further provides repeatedly performing the scalar multiplication operation by computing a value Q by multiplying the scalar k by the basic point P by using the two variables; and determining whether a fault was induced during the multiplication by analyzing the relationship between the two variables and the basic point P, and outputting the value Q or a warning signal STOP according to the determination result.

### BRIEF DESCRIPTION OF THE DRAWINGS

Exemplary embodiments of the present invention will be understood in more detail from the following descriptions taken in conjunction with the attached drawings in which:

FIG. 1 is a flowchart of a conventional CT&C (Calculate Twice and Check) method providing a countermeasure against differential fault analysis (DFA);

FIG. 2 is a flowchart of a conventional COP (Check-the-Output-Point) method of providing a countermeasure against DFA;

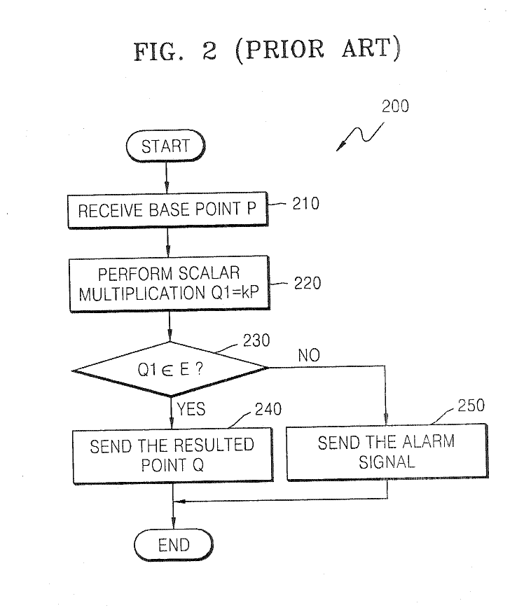

FIG. 3 is a flowchart of a Montgomery power ladder algorithm (MPLA) that provides a countermeasure against DFA according to an exemplary embodiment of the present invention;

FIG. 4 is a flowchart of an MPLA that provides a countermeasure against DFA according to an exemplary embodiment of the present invention; and

FIG. 5 is a flowchart of an MPLA that provides a countermeasure against DFA according to an exemplary embodiment of the present invention.

### DETAILED DESCRIPTION OF EXEMPLARY EMBODIMENTS

Hereinafter, exemplary embodiments of a display system using a mobile communication terminal according to the present invention will be described in detail with reference to the accompanying drawings. Like reference numerals denote like elements throughout the drawings.

An elliptic curve E and a point P on the elliptic curve E as a system parameter are selected in an ECC cryptographic system. A first user of the ECC cryptographic system randomly generates an integer d, and obtains a value Q(=d×P) by multiplying the point P by the integer d. The first user discloses the value Q as an open key to other users, and securely stores the integer d as a secret key.

When a second user desires to transmit a message M to the first user in a secret manner, the second user randomly generates an integer k and obtains a value A(=k×P) by multiplying the point P by the integer k. Next, a value B(=M+kQ) is obtained using the open key Q provided by the first user and the message M to be sent. Lastly, the second user sends the first user a cryptograph (A,B) as a final result.

Upon receiving the cryptograph (A,B) from the second user, the first user computes dA using his/her secret key d, and restores the message M by performing an operation given by:
M=B−dA (1)

An addition operation and a scalar operation of Equation (1) above are the major operations performed in the open key-based ECO cryptographic system.

A point (x,y) on an elliptic curve E satisfies the following equation:
E: y²+a₁^{xy}+a₃^{y}=x³+a₂x²+a₄^{x}+a₆ (2)

In cryptography, the characteristics of the elliptic curve given by Equation (2) above are used for an operation in a prime finite field GF(p) or a binary finite field GF(2)ⁿ. In this exemplary embodiment, the prime finite field GF(p) indicates a field in which the number of elements is limited to a prime number p and, therefore, there is only one prime finite field GF(p).

In the prime finite field GF(p), a variable R=(x₃, y₃) that is a sum of two different variables P=(x₁, y₁) and Q=(x₂, y₂) is computed by:

$$\begin{matrix}θ = \frac{{y}_{2} - {y}_{1}}{{x}_{2} - {x}_{1}} \\ {x}_{3} = {θ}^{2} - {x}_{1} - {x}_{2} \\ {y}_{3} = θ ( {x}_{1 } - {x}_{3} ) - {y}_{1}\end{matrix} \qquad ( 3 )$$

In the prime finite field GF(p), when the two variables P and Q are the same, the variable R is computed by:

$$\begin{matrix}θ = \frac{{}_{}^{3}{x}{}_{}^{2} + {a}_{4}}{2 y} \\ {x}_{3} = {θ}^{2 } - 2 x \\ {y}_{3} = θ ( x - {x}_{3} ) - y ,\end{matrix} \qquad ( 4 )$$

wherein, since the two variables P and 0 are the same, x indicates x₁ and x₂, and y indicates y₁ and y₂.

In the binary finite field GF(2)ⁿ, a variable R=(x₃, y₃) that is a sum of two different variables P=(x₁, y₁) and Q=(x₂, y₂) is computed by:

$$\begin{matrix}θ = \frac{{y}_{2} + {y}_{1}}{{x}_{2} + {x}_{1}} \\ {x}_{3} = {θ}^{2} + θ + {x}_{1} + {x}_{2} + {a}_{4} \\ {y}_{3} = θ ( {x}_{1} + {x}_{3} ) + {x}_{3} + {y}_{1}\end{matrix} \qquad ( 5 )$$

In the binary finite field GF(2)ⁿ, when the two variables P and Q are the same, the variable R is computed by:

$$\begin{matrix}θ = x + \frac{y}{x} \\ {x}_{3} = {θ}^{2} + θ + {a}_{4} \\ {y}_{3} = θ ( x + {x}_{3} ) + {x}_{3} + y\end{matrix} \qquad ( 6 )$$

A scalar multiplication operation for computing a value Q(=k×P) by multiplying the point P on the elliptic curve E by a constant k, is also one of the major operations performed in the ECG cryptographic system. In this exemplary embodiment, the constant k denotes a secret key, and the value Q is obtained by multiplying P by k. A discrete logarithm operation is performed to obtain the value k using the values Q and P. The discrete logarithm operation is performed by using the elliptic curve characteristics in finite fields, and the secrecy of the cryptographic protocol is based on the discrete logarithm operation.

The scalar multiplication operation is based on a point operation, that is, a finite field operation. In general, the Montgomery Power Ladder Algorithm (MPLA) is often used to perform scalar multiplication operations. MPLA was originally designed to deal with a simple power analysis attack, but has frequently been applied not only to scalar operations performed in all fields of ECC, but also to a modular exponentiation operation performed in RSA cryptography.

Hereinafter, the scalar multiplication operation using the MPLA in ECC will be described.

In the MPLA, two variables Lᵢ and Hᵢ are defined as follows:

$${L}_{j} = {\sum }_{i = j}^{j - 1} {k}_{i} {2}^{i - j} \\ {H}_{j} = {L}_{j} + 1 , \qquad ( 7 )$$

wherein k denotes an integer that can be expressed as a plurality of binary bits kₜ₋₁, kₜ₋₂, . . . , k₁, k₀; k₁ is one of the binary bits kₜ₋₁, kₜ₋₂, . . . k₁, k₀; and kₜ₋₁ always has a value of 1. The relationship between the two variables Lⱼ and Hⱼ in Equation (7) may also be expressed as follows.

$$\begin{matrix}{L}_{j} = {}_{}^{2}{L}{}_{j + 1}^{} + {k}_{j} \\ = {L}_{j + 1} + {H}_{j + 1} + {k}_{j} - 1 \\ = {}_{}^{2}{H}{}_{j + 1}^{} + {k}_{j} - 2\end{matrix} \qquad ( 8 )$$

The relationship between the two variables Lⱼ and Hⱼ can also be expressed using Equation (8) and a binary bit kⱼ determined by a variable j, as follows:

$$( {L}_{j} , {H}_{j} ) = \begin{matrix}{(}^{2} {L}_{j + 1} , {L}_{j + 1} + {H}_{j + 1} ) if {k}_{j} = 0 \\ ( {L}_{j + 1} + {H}_{j + 1} , {}_{}^{2}{L}{}_{j + 1}^{} , ) if {k}_{j} = 1\end{matrix} \qquad ( 9 )$$

Using Equations (3) through (8) set forth above, the conventional MPLA for computing Q(=k×P) by performing a scalar multiplication operation can be expressed as follows:
input: k=(kₜ₋₁, kₜ₋₂, . . . , k₁, k₀)₂, with kₜ₋₁=1(x₁,y₁)
output; kP(x₃,y₃)

1. P₁←P

2. P₀←2P

3. for i=t-2 to 0, do
3.1 if kᵢ=1 then
   P₁←P₁+P₀; P₀←2P₀
3.2 else
   P₀←P₁+P₀; P₁←2P

end for;

4. return kP(x₃,y₃)

In operation 3 above, an initial value of a variable i is set to t-2, since a case where the variable i is equal to t-1 has already been considered in operations 1 and 2. The addition operation (P₁+P₀) is obtained using Equations (3) through (6) set forth above. Referring to operations 1 and 2, P₁ and P₀ are not the same and, thus, Equations (3) and (5) are used in the addition operation (P₁+P₀).

According to Equation (7) showing the relationship between the two variables Lⱼ and Hⱼ, the difference between the variables Lⱼ and Hⱼ is always 1 when a predetermined fault is not induced in an operation performed in the cryptographic system. This means that the difference between the variables Pᵢ and P₀ used in the conventional MPLA is always P.

A probability that two random faults are induced is approximately equal to 0, since the difference between two variables Pᵢ and P₀ will always be P, that is, a result obtained when no fault is induced. This is well-known to those of ordinary skill in the art and thus will not be considered in this disclosure.

If the variables Pᵢ, P₀, and p that are randomly selected in the conventional MPLA satisfy one of the following three equations, which are different representations of the same condition, it can be determined that no fault is induced.
P₀−P₁=P
P₀−P=P₁
P₁+P=P₀ (10)

Meanwhile, a method of determining whether a fault is induced in an ECC system may be applied to an algorithm that performs a modular exponentiation operation performed in an RSA system, as follows:

$${R}_{0} \cdot \frac{1}{{R}_{1}} = M \\ {R}_{0} \cdot \frac{1}{M} = {R}_{1} \\ {R}_{1} \cdot M = {R}_{0} , \qquad ( 11 )$$

wherein the three variables M, R₁, and R₀ correspond to the three variables P, P₁, and P₀ in Equation (10), respectively. Since those of ordinary skill in the art can easily derive Equations (10) and (11), a detailed description thereof will be omitted.

Whether a fault is induced during an operation may be determined by determining in the ECC system whether the three variables P, P₁, and P₀ satisfy one of the three equations in Equation (10) above, and determining in the RSA system whether the three variables M, R₁, and R₀ satisfy one of the three equations in Equation (11).

Exemplary embodiments of the present invention provide an algorithm obtained by including an operation of determining the relationship between three variables, shown in Equation (10) or Equation (11), in algorithms applied to ECC and RSA systems. The algorithm can be applied to various cryptographic systems without degrading the performance of the system.

Exemplary embodiments of the present invention also provide three methods, that is, a regular check, a random check, and an at-the-end check, which are categorized according to a location of the algorithm to which the above operations of determining the relationship between three variables are applied. More specifically, the above operations are performed during the scalar multiplication operation (the regular check and the random check), and before the result thereof is output after repeatedly performing the scalar multiplication operation (the at-the-end check).

That is, in the regular check, the above operations are performed in each of the scalar multiplication operations that are repeatedly performed: in the random check, the above operations are performed in some of the scalar multiplication operations that are repeatedly performed, and in the at-the-end check; the above operations are performed before outputting the result of the scalar multiplication operation after repeatedly performing the scalar multiplication operations.

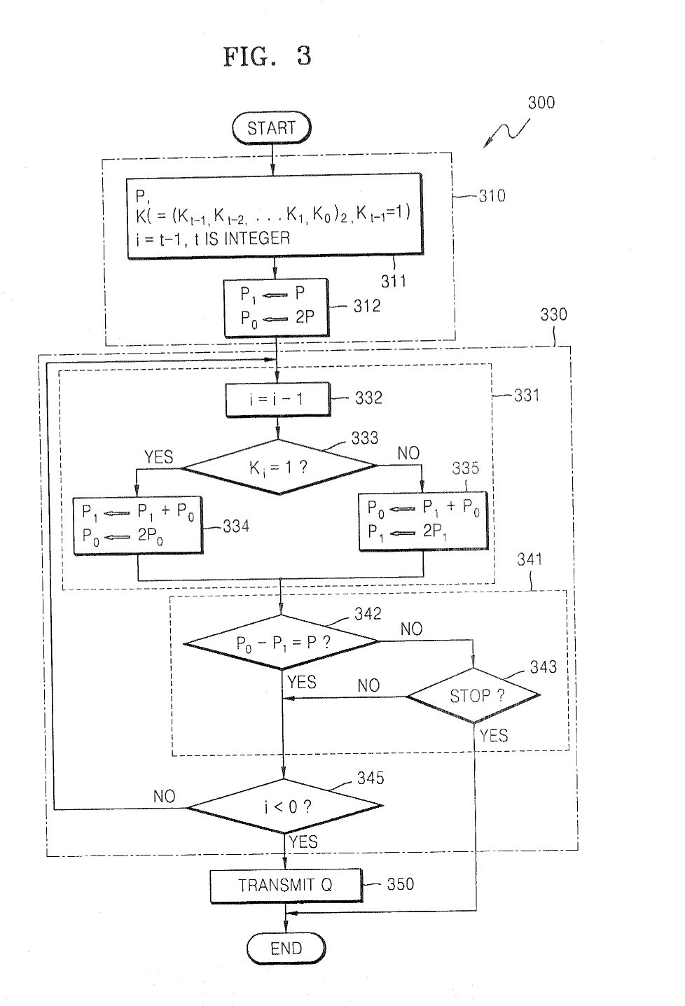

First, an MPLA that uses the regular check according to an exemplary embodiment of the present invention will be described with reference to FIG. 3.

FIG. 3 is a flowchart illustrating an MPLA 300 that provides a countermeasure against DOA by using the regular check, according to an exemplary embodiment of the present invention. Referring to FIG. 3, the MPLA 300 includes an initialization operation 310, a repetitive arithmetic operation 330, and a transmission operation 350.

The initialization operation 310 includes setting an initial value of a variable i, which is to be used in the repetitive arithmetic operation 330, to t-1, receiving a basic point P and a scalar k (311), and replacing a first variable P1 with the basic point P and a second variable P0 with 2P, which is a double of the basic point P (312) (t is an integer). The scalar k denotes a binary bit that can be expressed as (kₜ₋₁, kₜ₋₂, . . . , k₁, k₀)₂.

In the repetitive arithmetic operation 330, the scalar multiplication operation is repeatedly performed using the two variables P₁ and P₀ to compute a value Q by multiplying the basic point P by the scalar k, the relationship between the two variables P₁ and P₀ and the basic point P is checked during the multiplication so as to determine whether a fault was induced and one of the value Q and a warning signal STOP is output according to the checking result.

The repetitive arithmetic operation 330 includes replacing variables (331), determining whether a fault was induced and taking measures according to the operation result (341), and determining whether the variable i is less than 0 (zero) (345). The variable replacement operation 331 includes performing the scalar multiplication operation by reducing the variable i by one (332), determining whether a binary bit kᵢ corresponding to the scalar k is 1 according to the variable i (333), replacing a first variable P1 and replacing a second variable P0 corresponding to 334 or 335. In detail, operation 334 is performed when ki is 1, in which the first variable P1 is replaced with a sum (P1+P0) of the first variable P1 and the second variable P₀, and the second variable P₀ is replaced with 2P₀, which is a double of the second variable P₀. Operation 335 is performed when kᵢ has a value other than 1, in which the first variable P₀ is replaced with a sum (P₁+P₀) of the first and second variables P₁ and P₀, and the second variable P₁ is replaced with 2P, that is double the second variable P₁.

In operation 341 it is determined whether the relationship between the first and second variables P₁ and P₀ and the basic point P satisfies predetermined conditions, and the multiplication operation is continued or discontinued while generating the warning signal STOP.

Operation 341 includes determining whether a fault is induced (342) and taking measures (343). In operation 342, it is determined whether the relationship between the two variables P₀ and P₁ replaced in operation 331 and the initial basic point P satisfies one of the three equations P₀−P₁=P, P₀−P=P₁, and P₁+P=P₀ in Equation (10) set forth above. If it is determined that the relationship satisfies one of the three equations, it is determined whether the variable i is 0 (zero) (345). In operation 343, when the relationship does not satisfy any one of the three equations, it is determined whether the multiplication operation is to be discontinued. When it is determined that the multiplication operation it to be discontinued, the warning signal STOP is generated, and when it is determined that the multiplication operation is to be continued, it is determined whether the variable i is 0 (zero) (345).

Until it is determined that the multiplication operation it to be discontinued, operation 331 is repeatedly performed until the variable i becomes 0 (zero).

In operation 350, the value Q is transmitted to a predetermined operation device.

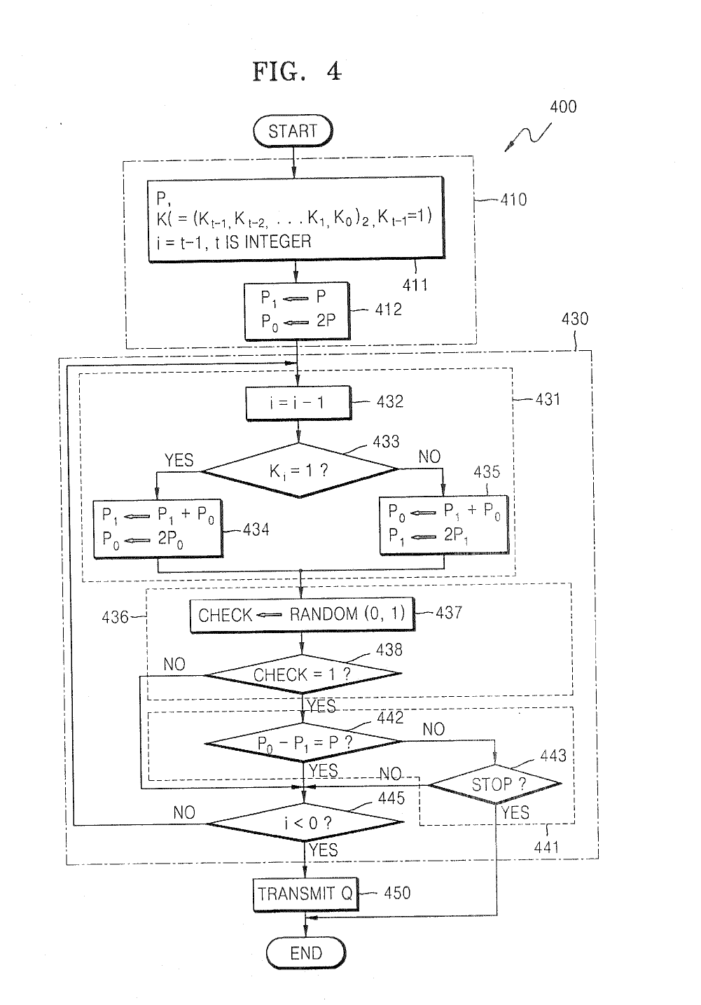

Next, an MPLA that uses the random check according to an exemplary embodiment of the present invention will be described with reference to FIG. 4,

FIG. 4 is a flowchart illustrating an MPLA 400 that provides a countermeasure against DFA by using the random check, according to an exemplary embodiment of the present invention. Referring to FIG. 4, the MPLA 400 includes an initialization operation 410, a repetitive arithmetic operation 430, and a transmission operation 450.

First, a scalar k is set to a binary bit that is expressed as (kₜ₋₁, kₜ₋₂, . . . , k₁, k₀)₂. The initialization operation 410 and the transmission operation 450 are respectively the same as the initialization operation 310 and the transmission operation 350 of the MPLA 300 according to an exemplary embodiment of the present invention.

The repetitive arithmetic operation 430 includes replacing variables (431), determining whether determination of whether a fault was induced will be performed according to a variable check value (436), determining whether a fault was induced and taking measures (441), and determining whether a variable i to be used in the repetitive arithmetic operation 430 is less than 0 (zero) (445).

Operation 431 is the same as operation 331 illustrated in FIG. 3.

Operation 436 includes allocating a random number to the variable check value (437), and determining whether the allocated number is equal to a predetermined reference value (438). Operation 441 is performed when the allocated number is equal to the predetermined reference value, and the multiplication operation is continued otherwise (445), which is different from the regular check described with reference to FIG. 3. In the regular check, whether a fault was induced is determined whenever the scalar multiplication operation is performed, but in the random check of FIG. 4, a variable check value is randomly selected and whether determination of whether a fault was induced will be performed according to the variable check value. Accordingly, the number of times that whether a fault was induced is determined in the MPLA 400 of FIG. 4 is less than in the MPLA 300 of FIG. 3. In FIG. 4, the predetermined reference value is set to 1, but decision module (436) can be slightly modified to provide the ability of adaptively changing the randomness rate in the system.

Operation 441 is the same as operation 341 of FIG. 3.

If it is determined in operation 445 that the variable i is equal to or greater than 0, the operation 431 is performed and the scalar multiplication operation is continuously performed.

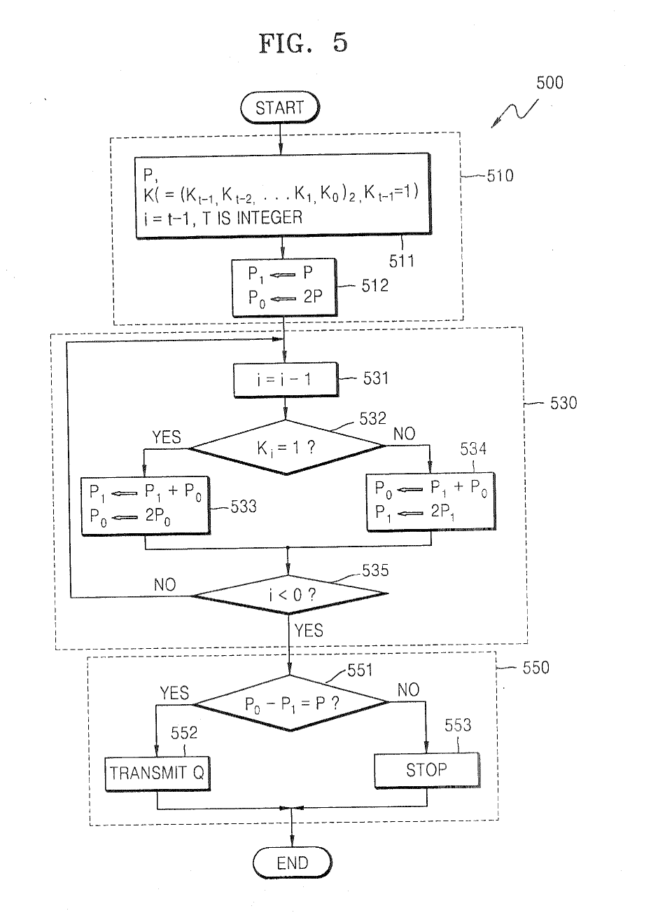

Lastly, an MPLA that uses the at-the-end check according to an exemplary embodiment of the present invention will be described with reference to FIG. 5.

FIG. 5 is a flowchart illustrating an MPLA 500 that provides a countermeasure against DFA by using the at-the-end check, according to an exemplary embodiment of the present invention, Referring to FIG. 51 the MPLA 500 includes an initialization operation 510, a repetitive arithmetic operation 530, and a transmission operation 550.

First, a scalar k is set to a binary bit that is expressed as (kₜ₋₁, kₜ₋₂, . . . , k₁, k₀)₂. The initialization operation 510 is the same as the initialization operation 310 of FIG. 3 and the initialization operation 410 of FIG. 4.

In the repetitive arithmetic operation 530, the scalar multiplication operation is performed using two variables to compute a value Q by multiplying the scalar k and a basic point P.

The repetitive arithmetic operation 530 includes reducing a variable i, which is to be used therein, by one (531), determining whether a binary bit kᵢ corresponding to the scalar k is 1 according to the variable i (532), replacing a first variable P₁ (533), replacing a second variable P₀ (534), and determining whether the variable i is less than 0 (zero) (535). Operation 533 is performed when kᵢ is 1, in which the second variable P₀ is replaced with 2P₀ that is a double of the second variable P₀ and the first variable P₁ is replaced with a sum (P₁+P₀) of the first and second variables P₁ and P₀. Operation 534 is performed when kᵢ is not 1, in which the first variable P₁ is replaced with two times the second variable P₀, that is, 2P₀, and the second variable P₀ is replaced with the sum (P₁+P₀) of the first and second variables P₁ and P₀.

If it is determined in operation 535 that the variable i is equal to or greater than 0, operation 531 is performed, otherwise operation 550 is performed.

In operation 550, the predetermined relationship between the two variables P₁ and P₀ and the basic point P is analyzed to determine whether a fault was induced, and the value Q or the warning signal STOP is output according to the analysis result.

Operation 550 includes determining whether a fault was induced (522), outputting the value Q (552), and generating the warning signal STOP (553). In operation 551, it is determined whether the relationship between the two variables P₁ and P₀ replaced in operation 533 or 534 and the initial basic point P satisfies one of three equations P₀−P₁=P, P₀−P=P₁, and P₁+P−P₀ in Equation (10). In operation 552, when the relationship satisfies one of the three equations, the value Q is output. In operation 553, when the relationship does not satisfy any one of the three equations, the warning signal STOP is generated.

There are many cases where the warning signal STOP generated in operation 343, 443, or 553 shown in FIGS. 3 through 5 can be used. These cases are as follows:

1. when an operation that is being performed is discontinued, register values used in the operation are set or reset, and an output is set to 0 (zero).

2. when fault diffusion is applied to a secret key value and an operation is continuously performed (see Korean Patent Application No. 2005-0022929);

3. when an output point is modified and used (see Korean Patent Application No 2005-0018429).

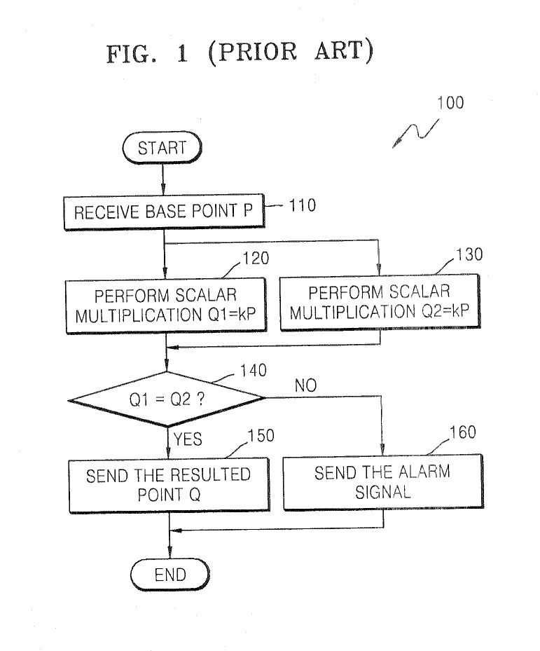

The MPLA 300, shown in FIG. 3, which uses the regular check, allows measures to be taken immediately when a fault is induced and, therefore, is applicable to a high-rank secret cryptographic system. The MPLA 300 degrades the performance of the cryptographic system, however, but the performance of the cryptographic system is higher than when using the conventional CT&T method of FIG. 1.

The MPLA 400, shown in FIG. 4, which uses the random check, has the advantages of the MPLA 300 that uses the regular check, and the performance of the cryptographic system in this case is higher than when using the MPLA 300.

When using the MPLA 500, shown in FIG. 5, which uses the at-the-end check, the performance of the cryptographic system is higher than when using the MPLAs 300 and 400.

The greatest advantage of the MPLA according to the exemplary embodiment of the present invention, however, is to provide an active countermeasure for not only DFA but also an ability to increase the complexity of power analysis attack. This can be provided by implementing indistinguishable basic EC points operations, such as point addition and point doubling, and employing the usage of the random check technique.

The MPLAs, according to exemplary embodiments of the present invention have been described with regard to a scalar multiplication operation. Those of ordinary skill in the art, however, can easily modify the MPLAs to apply them to the modular exponentiation operation performed in an RSA system, based on the relationship between the scalar multiplication operation performed in an ECG system and the modular exponentiation operation performed in an RSA system.

As described above, it is possible to actively deal with a DFA-based attack against a cryptographic system using the MPLAs according to the exemplary embodiments of the present invention.

The specific terms used in the present disclosure are not intended to restrict the scope of present invention, and are only used for a better understanding of the present invention. While this invention has been particularly shown and described with reference to exemplary embodiments thereof it will be understood by those skill in the art that various changes in form and details may be made therein without departing from the spirit and scope of the invention as defined by the appended claims.

What is claimed is:

1. A Montgomery power ladder algorithm that provides a countermeasure against differential fault analysis (DFA) by performing a scalar multiplication operation in a prime finite field or a binary finite field, the algorithm comprising:
initializing at least two variables by setting an initial value of a variable i, which is to be used in a repetitive arithmetic operation, receiving a basic point P on an elliptic curve and a scalar k; and initializing the at least two variables using the basic point P; and
repeatedly performing the scalar multiplication operation by computing a value Q by multiplying the scalar k by the basic point P using the two variables, determining whether a fault was induced during the multiplication by analyzing the relationship between the two variables and the basic point P, and outputting the value Q or a warning signal STOP according to a determination result from the step of determining.

2. The algorithm of claim 1, wherein the step of determining whether a fault was induced is performed in each of the scalar multiplication operations that are repeatedly performed to compute the value Q, or in specific cases of the scalar multiplication operations that are repeatedly performed.

3. The algorithm of claim 2 wherein the step of initializing the at least two variables comprises:
setting an initial value of the variable i to t-1, and receiving the basic point P and the scalar k, where t is an integer; and
replacing a first variable P₁ with the basic point P, and a second variable P₀ with 2P that is two times the basic point P.

4. The algorithm of claim 3, wherein, when the scalar k is a binary bit expressed as (kᵢ₋₁, kᵢ₋₂, . . . , k₁, k₀)₂, the repeatedly performing of the scalar multiplication operation comprises;
replacing the first and second variables P₁ and P₀ with predetermined values according to kᵢ while changing the variable i, where kᵢ is one of binary bits corresponding to the scalar k;
determining whether the fault was induced and taking measures to eliminate the fault by determining whether the relationship between the first and second variables P₁ and P₀ and the basic point P satisfies predetermined conditions and determining whether the scalar multiplication operation is to be continued or the warning signal STOP is to be output; and
determining whether the variable i is less than 0,
wherein the step of replacing the first and second variables P₁ and P₀ with predetermined values is repeatedly performed until the variable i becomes 0 before it is determined that the scalar multiplication operation is to be discontinued.

5. The algorithm of claim 4, wherein the step of replacing the first and second variables P₁ and P₀ with predetermined values comprises:
reducing the variable i by 1;
determining whether kᵢ is 1;
when kᵢ is 1 replacing the first variable P₁ with a sum P₁+P₀ of the first and second variables P₁ and P₀, and the second variable P₀ with a double 2P₀ of the second variable P₀; and
when K is not 1, replacing the second variable P₀ with the sum P₁+P₀ of the first and second variables P₁ and P₀, and the first variable P₁ with 2P₀ that is two times the second variable P₀.

6. The algorithm of claim 4, wherein the step of determining whether the fault was induced and taking measures to eliminate the fault comprises:
determining whether the relationship between the variables P₁ and P₀, which are replaced in the replacing of the first and second variables P₁ and P₀ with predetermined values, and the basic point P satisfies one of three equations P₀−P₁=P, P₀−P=P₁, and P₁+P=P₀; and determining whether the variable i is 0 when the relationship satisfies one of the three equations, where the three equations are different representation of the same condition; and
determining whether the scalar multiplication operation is to be discontinued when the relationship does not satisfy any one of the three equations, generating the warning signal STOP when it is determined that the scalar multiplication operation is to be discontinued, and determining whether the variable i is 0 when it is determined that the scalar multiplication operation is to be continued.

7. The algorithm of claim 3, wherein, when the scalar k is a binary bit expressed as (kᵢ₋₁, kᵢ₋₂, . . . , k₁, k₀)₂, the step of repeatedly performing the scalar multiplication operation comprises:
replacing the first and second variables P₁ and P₀ with predetermined values according to kᵢ while changing the variable i, where kᵢ is one of binary bits corresponding to the scalar k;
determining whether the step of determining whether the fault was entered is to be performed according to a variable check value;
determining whether the fault was entered and taking measures to eliminate the fault by determining the relationship between the first and second variables P₁ and P₀ and the basic point P according to the variable check value, and determining that the scalar multiplication operation is to be continued, or discontinuing the scalar multiplication operation and generating the warning signal STOP; and
when it is determined that the scalar multiplication operation is to be continued, determining whether the variable i is less than 0,
wherein when it is determined that the variable i is equal to or greater than 0, replacing the first and second variables P₁ and P₀ with the predetermined values.

8. The algorithm of claim 7, wherein the step of replacing the first and second variables P₁ and P₀ comprises:
reducing the variable i by 1;
determining whether kᵢ is 1:
when kᵢ is 1, replacing the first variable P₁ with a sum P₁+P₀ of the first and second variables P₁ and P₀, and the second variable P₀ with 2P₀ that is two times the second variable P₀; and
when kᵢ is not 1, replacing the second variable P₀ with the sum P₁+P₀ of the first and second variables P₁ and P₀, and the first variable P₁ with 2P₀ that is two times the second variable P₀.

9. The algorithm of claim 8, wherein the step of determining whether the fault was induced comprises:
setting the variable check value to a random value, and
determining whether the variable check value is equal to a predetermined reference value,
wherein whether the fault was induced is determined when the variable check value is equal to the predetermined reference value, otherwise the scalar multiplication operation is continued.

10. The algorithm of claim 9, wherein the variable check value is set according to a randomness rate in the system.

11. The algorithm of claim 8, wherein the step of determining whether the fault was induced comprises:
determining whether the relationship between the variables P₁ and P₀, which are replaced in the replacing of the first and second variables P₁ and P₀ with predetermined values, and the basic point P satisfies one of three equations P₀−P₁=P, P₀−P=P₁, and P₁+P=P₀, and determining whether the variable i is 0 when the relationship satisfies one of the three equations, where the three equations are different representations of the same condition, and
determining whether the scalar multiplication operation is to be discontinued when the relationship does not satisfy any one of the three equations generating the warning signal STOP when it is determined that the scalar multiplication operation is to be discontinued, and determining whether the variable i is 0 when it is determined that the scalar multiplication operation is to be continued.

12. The algorithm of claim 3, further comprising transmitting the value Q to an operation device.

13. A Montgomery power ladder algorithm that provides a countermeasure against differential fault analysis (DFA) by performing a scalar multiplication operation in a prime finite field or a binary finite field, the algorithm comprising:
initializing at least two variables by setting an initial value of a variable i which is to be used in a repetitive arithmetic operation, receiving a basic point P on an elliptic curve and a scalar k, and initializing the at least two variables using the basic point P;
repeatedly performing the scalar multiplication operation by computing a value Q by multiplying the scalar k by the basic point P by using the two variables;
determining whether a fault was induced during the multiplication by analyzing the relationship between the two variables and the basic point P, and outputting the value Q or a warning signal STOP according to a determination result from the step of determining.

14. The algorithm of claim 13, wherein the step of initializing the at least two variables comprises:
setting an initial value of the variable i to t-1, and receiving the basic point P and the scalar k, where t is an integer; and
replacing a first variable P, with the basic point P, and a second variable P₀ with 2P that is two times the basic point P.

15. The algorithm of claim 14, wherein, when the scalar k is a binary bit expressed as (kₜ₋₁, kₜ₋₂, . . . , k₁, k₀)₂, the step of replacing the first and second variables P₁ and P₀ comprises:
reducing the variable by 1;
determining whether kᵢ corresponding to the scalar k is 1;
when kᵢ is 1,replacing the second variable P₀ with 2P₀ that is two times the second variable P₀, and the first variable P₁ with a sum P₁+P₀ of the first and second variables P₁ and P₀;
when kᵢ is not 1, replacing the second variable P₀ with the sum P₁+P₀ of the first and second variables P₁ and P₀, and the first variable P₁ with 2P₀ that is two times the second variable P₀; and
determining whether the variable i is less than 0,
wherein the variable i is reduced by 1 when it is determined that the variable i is equai to or greater than 0, and whether a fault is entered is determined, otherwise measures to eliminate the fault are taken.

16. The algorithm of claim 14, wherein the step of determining whether the fault was induced and taking measures to eliminate the fault comprises:
determining whether the fault was induced by determining whether the relationship between the variables P₁ and P₀, which are replaced in the replacing of the first and second variables P₁ and P₀ with predetermined values, and the basic point P satisfies one of three equations P₀−P₁=P, P₀−P=P₁, and P₁+P==P₀;
if it is determined that the relationship satisfies one of the three equations, the value Q is output; and
if it is determined that the relationship does not satisfy any one of the three equations, generating the warning signal STOP.

17. A computer readable medium tangibly embodying a computer code executable by the computer for executing the Montgomery power ladder algorithm of claim 1.

18. A cryptographic system that uses the computer readable medium of claim 17.

19. A computer readable medium tangibly embodying a computer code executable by the computer for executing the Montgomery power ladder algorithm of claim 13.

20. A cryptographic system that uses the computer readable medium of claim 19.
